(19) United States
(12) Patent Application Publication
(10) Pub. No.: US 2019/0296531 A1
(43) Pub. Date: Sep. 26, 2019

(54) WIRE PROTECTION MEMBER AND PIPE HARNESS

(71) Applicants: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP)

(72) Inventor: Hironobu RACHI, Yokkaichi (JP)

(73) Assignees: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP)

(21) Appl. No.: 16/291,626

(22) Filed: Mar. 4, 2019

(30) Foreign Application Priority Data
Mar. 22, 2018 (JP) 2018-054469

(51) Int. Cl. H02G 3/04; H01B 7/00

(52) U.S. Cl. CPC H02G 3/0406; H02G 3/0481; H01B 7/0045

(57) ABSTRACT

A wire protection member that includes a metal pipe in which a wire that forms a wire harness is to be inserted; and a coating film that covers an outer surface of the metal pipe, wherein the coating film is formed of a cured product of an ultraviolet-curable resin coating material, and the cured product has a bonding strength of 0.3 MPa or more, and an elongation of 1% or more.

This application claims priority from JP 2018-054469 filed Mar. 22, 2018, the entire disclosure of which is incorporated herein by reference.

### BACKGROUND

The present disclosure relates to a wire protection member and a pipe harness.

Conventionally, techniques have been known by which a pipe harness is formed by inserting, into a pipe-shaped wire protection member, a wire that forms a wire harness routed under the floor of a vehicle such as an automobile in order to protect the wire harness. The surface of the wire protection member of a pipe harness of this type is often colored in a specific color in order to indicate that a high-voltage current is passing through the wire.

For example, JP 2013-223342A describes a technique by which a resin identification portion that is colored in a specific color is formed on the pipe surface through extrusion molding or the like. In addition, JP 2014-50267A and JP 2014-50268A describe techniques by which an identification mark is formed on a part of the outer surface of the pipe body by using a colorant such as a coating material or a tape.

JP 2013-223342A, JP 2014-50267A, and JP 2014-50268A are examples of related art.

### SUMMARY

Meanwhile, in the case of using a metal pipe for the wire protection member and coloring the metal pipe in a specific color through bake coating, the Joule heat that is generated by passing a current through a wire of the wire harness is transferred to the coating film on the surface of the metal pipe, resulting in cracking or detachment of the coating film. This phenomenon is particularly prominent when the coating film is colored with a pigment.

The present disclosure provides a wire protection member capable of inhibiting cracking and detachment of the coating film caused by Joule heat, and a pipe harness using the same.

An aspect of the present disclosure is directed to a wire protection member including: a metal pipe in which a wire that forms a wire harness is inserted; and a coating film that covers an outer surface of the metal pipe, wherein the coating film is formed of a cured product of an ultraviolet-curable resin coating material, and the cured product has a bonding strength of 0.3 MPa or more, and an elongation of 1% or more.

Another aspect of the present disclosure is directed to a pipe harness including: the wire protection member; and the wire that forms the wire harness, the wire being inserted in the metal pipe of the wire protection member.

In the wire protection member, the coating film that covers the outer surface of the metal pipe is formed of a cured product of an ultraviolet-curable resin coating material, and the cured product has a bonding strength of 0.3 MPa or more, and an elongation of 1% or more. Accordingly, with the use of the wire protection member, the wire harness can withstand the stress and the distortion generated between the metal pipe and the coating film even when Joule heat is generated by passing a current through the wire of the wire harness, and it is possible to inhibit cracking and detachment of the coating film.

The pipe harness includes the wire protection member, and a wire that forms the wire harness, the wire being inserted in a metal pipe of the wire protection member. Accordingly, the pipe harness can inhibit cracking and detachment of the coating film caused by Joule heat.

### BRIEF DESCRIPTION OF THE DRAWINGS

FIG. 1 is a perspective view schematically showing a wire protection member according to Embodiment 1.

### DETAILED DESCRIPTION OF EMBODIMENTS

A wire protection member includes a metal pipe in which a wire that forms a wire harness is inserted, and a coating film that covers an outer surface of the metal pipe.

In terms of the weight reduction and the like, aluminum, an aluminum alloy, or the like may preferably be used as a metal (including, an alloy) that forms the metal pipe. The metal pipe may be bent as appropriate according to the routing configuration of the wire harness.

Specifically, the coating film can cover the outer surface of the metal pipe in the circumferential direction of the pipe. The coating film may cover the entire outer surface of the metal pipe in the circumferential direction of the pipe, or may partially cover the outer surface of the metal pipe in the circumferential direction of the pipe. For example, when the pipe harness is routed under the floor of a vehicle, at least a surface on the road side of the outer surfaces of the metal pipe may be covered by the coating film, from the viewpoint of preventing the metal pipe, for example, from being scratched by a flying stone or the like.

The coating film is formed of a cured product of an ultraviolet-curable resin coating material. Here, the cured product has a bonding strength of 0.3 MPa or more, and an elongation of 1% or more. When the bonding strength of the cured product is less than 0.3 MPa, the coating film tends to become detached in 150° C. and 180° C. heat tests, and the heat resistance of the coating film is reduced. Since the coating film is less likely to be detached in 120° C., 150° C., and 180° C. heat tests, and the heat resistance of the coating film is increased, the bonding strength of the cured product may preferably be 0.35 MPa or more, more preferably 0.4 MPa or more, still more preferably 0.45 MPa or more, or even more preferably 0.5 MPa or more. On the other hand, from the viewpoint of easily ensuring the required elongation of the cured product, the bonding strength of the cured product may preferably be 1.5 MPa or more, more preferably 1.7 MPa or more, or still more preferably 2 MPa or more. Also, when the elongation of the cured product is less than 1%, the coating film tends to be cracked in 150° C. and 180° C. heat tests, and the heat resistance of the coating film is reduced. Since the coating film is less likely to be cracked in 120° C., 150° C., and 180° C. heat tests, and the heat resistance of the coating film is increased, the elongation of the cured product may preferably be 1.5% or more, more preferably 2% or more, still more preferably 2.5% or more, or even more preferably 3% or more. On the other hand, from the viewpoint of easily ensuring the required bonding strength of the cured product, the elongation of the cured product may preferably be 200% or less, more preferably 180% or less, or still more preferably 150% or less.

Note that, the bonding strength of the cured product is a tensile shear strength measured in accordance with JIS K 6850. A glass plate and an aluminum plate are used as an adherend for forming a test strip. Specifically, the test strip is produced by applying an ultraviolet-curable resin coating material onto the bonding surface of the adherend, and irradiating the adherent from the glass plate side with ultra-violet light of 3000 mJ/cm² that is generated by a metal halide lamp. Also, the elongation of the cured product is an elongation at break that is measured in accordance with JIS K 6251. A No. 6 dumbbell-shaped test strip is used as a test strip. The No. 6 dumbbell-shaped test strip is produced by pouring an ultraviolet-curable resin coating material into a tetrafluoroethylene die hollowed out in a shape corresponding to the No. 6 dumbbell-shape, and irradiating the die with ultra-violet light of 3000 mJ/cm² that is generated by the metal halide lamp. The elongation can be measured by performing tensile tests using the thus obtained No. 6 dumbbell-shaped test strip.

Specifically, the ultraviolet-curable resin coating material may contain at least one of a (meth)acrylate monomer and a (meth)acrylate oligomer as the resin component.

With the above-described configuration, it is possible to reliably form a coating film having both a bonding strength and an elongation that can withstand the stress and the distortion, which is caused by Joule heat, between the metal pipe and the coating film. Note that the (meth)acrylate described above may include not only methacrylate, but also acrylate. This means that (meth)acryl described below may similarly include not only acryl, but also methacryl.

The (meth)acrylate monomer may be mono(meth)acrylate, may be poly(meth)acrylate, or may be a combination thereof. Examples of the mono(meth)acrylate include isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, (meth)acrylic acid, benzyl (meth)acrylate, 4-butylcyclohexyl (meth)acrylate, 2-hydroxyethyl (meth)acrylate, 2-hydroxypropyl (meth)acrylate, 4-hydroxybutyl (meth)acrylate, methyl (meth)acrylate, ethyl (meth)acrylate, propyl (meth)acrylate, isopropyl (meth)acrylate, octyl (meth)acrylate, isooctyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, polyethylene glycol mono(meth)acrylate, polypropylene glycol mono(meth)acrylate, methoxy ethylene glycol (meth)acrylate, ethoxyethyl (meth)acrylate, methoxy polyethylene glycol (meth)acrylate, methoxy polypropylene glycol (meth)acrylate, and polyoxyethylene nonylphenyl ether acrylate. These may be used alone or as a mixture of two or more.

Examples of the poly(meth)acrylate include butanediol di(meth)acrylate, hexanediol di(meth)acrylate, nonanethol di(meth)acrylate, decanediol di(meth)acrylate, 2-butyl-2-ethyl-1,3-propanediol di(meth)acrylate, 2-hydroxy-3-acryloyloxypropyl methacrylate, clipropylene glycol di(meth)acrylate, tripropylene glycol di(meth)acrylate, triethylene glycol di(meth)acrylate, tetraethylene glycol di(meth)acrylate, tricyclodecane dimethylol di(meth)acrylate, 1,4-butanepolyol di(meth)acrylate, 1,6-hexane polyol di(meth)acrylate, neopentyl glycol di(meth)acrylate, polyethylene glycol di(meth)acrylate, polypropylene glycol di(meth)acrylate, 9,9-bis[4-(2-acryloyloxy ethoxy)phenyl]fluorene, polyester di(meth)acrylate, tris(2-hydroxyethyl)isocyanurate tri(meth)acrylate, tris(2-hydroxyethyl)isocyanurate di(meth)acrylate, tricyclodecane dimethylol di(meth)acrylate, EO adduct di(meth)acrylate of bisphenol A, EO adduct or PO adduct polyol di(meth)acrylate of hydrogenated bisphenol A, epoxy(meth)acrylate obtained by adding (meth)acrylate to diglycidyl ether of bisphenol A, triethylene glycol divinyl ether, trimethylolpropane tri(meth)acrylate, pentaerythritol tri(meth)acrylate, trimethylol propane EO adduct tri(meth)acrylate, trisacryloyloxy ethyl phosphate, pentaerythritol tetra(meth)acrylate, tetrafurfuryl alcohol oligo(meth)acrylate, ethyl carbitol oligo(meth)acrylate, 1,4-butanediol oligo(meth)acrylate, 1,6-hexanediol oligo(meth)acrylate, trimethylolpropane oligo(meth)acrylate, pentaerythritol oligo(meth)acrylate, (poly)urethane (meth)acrylate, and (poly)butadiene (meth)acrylate. These may be used alone or as a mixture of two or more. Note that examples of the (meth)acrylate oligomer include oligomerized products of the (meth)acrylate monomers described above.

The ultraviolet-curable resin coating material may contain a pigment. A coating film using an ultraviolet-curable resin coating material containing a pigment exhibits tendency of being more likely to be cracked or detached by the Joule heat transferred from the metal pipe, as compared with a coating film using an ultraviolet-curable resin coating material containing no pigment. However, even when the ultraviolet-curable resin coating material contains a pigment, it is possible to effectively inhibit the coating film from being cracked or detached by the Joule heat if the bonding strength and the elongation of the cured product of the ultraviolet-curable resin coating material are set within specific ranges. As the pigment, it is possible to use a particulate pigment, for example. In addition, the pigment may be either an organic pigment or an inorganic pigment. For example, from the viewpoint of increasing the ease of identification, the coating film may exhibit a color such as orange by using the pigment.

When the ultraviolet-curable resin coating material contains a pigment, the pigment content in the ultraviolet-curable resin coating material may be 5 mass % or less. With this configuration, even when the ultraviolet-curable resin coating material contains a pigment, the bonding strength and the elongation of the cured product of the ultraviolet-curable resin coating material can be easily set within specific ranges. In terms of the balance between the bonding strength and the elongation, for example, the pigment content may preferably be 4.5 mass % or less, more preferably 4 mass % or less, or still more preferably 3.5 mass % or less. In terms of the colorability or the like, the pigment content may preferably be 0.1 mass % or more, more preferably 0.5 mass % or more, or still more preferably 0.8 mass % or more.

The thickness of the coating film may be 30 μm or more and 100 μm or less. When the thickness of the coating film is 30 μm or more, the metal pipe can easily be protected from a flying stone or the like. On the other hand, when the thickness of the coating film is 100 μm or less, the ultraviolet-curable resin coating material can be easily sufficiently cured when forming a coating film. The thickness of the coating film may preferably be 35 μm or more, more preferably 40 μm or more, or still more preferably 45 μm or more. On the other hand, the thickness of the coating film may preferably be 90 μm or less, more preferably 80 μm or less, or still more preferably 70 μm or less.

The pipe harness includes a metal pipe in which a wire that forms a wire harness is inserted, and a coating film that covers an outer surface of the metal pipe. The number of wires that form the wire harness is not particularly limited, and the wire harness may be formed by a plurality of wires. For example, the pipe harness may be configured to connect a power conversion apparatus and a battery, or a power conversion apparatus and a motor, in an electric car or a hybrid car.

Note that the above-described configurations may be freely combined as needed, for example, in order to achieve the above-described operations and effects.

### EMBODIMENTS

### Embodiment 1

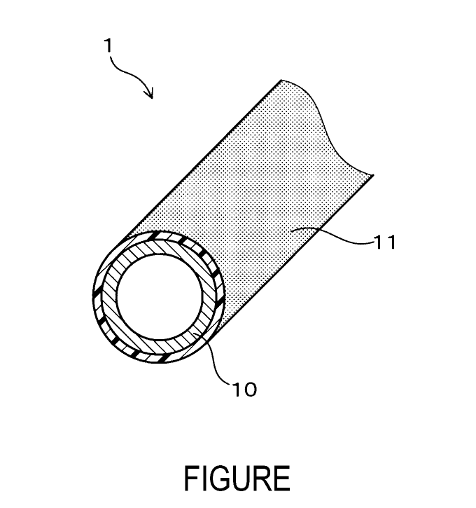

A wire protection member and a pipe harness according to Embodiment 1 will be described with reference to FIG. 1. As illustrated in FIG. 1, a wire protection member 1 according to the present embodiment includes a metal pipe 10 in which a wire (not shown) that forms a wire harness is inserted, and a coating film 11 that covers the outer surface of the metal pipe 10. The coating film 11 is formed of a cured product of an ultraviolet-curable resin coating material, and the cured product has a bonding strength of 0.3 MPa or more, and an elongation of 1% or more. In the present embodiment, the ultraviolet-curable resin coating material contains at least one of a (meth)acrylate monomer and a (meth)acrylate oligomer, and a pigment. The pigment content in the ultraviolet-curable resin coating material is 5 mass % or less.

A pipe harness (not shown) of the present embodiment includes a wire protection member 1 of the present embodiment, and a wire (not shown) that forms a wire harness, the wire being inserted in the metal pipe 10 of the wire protection member 1.

In the following, the wire protection member and the pipe harness will be described more specifically by way of working examples.

### WORKING EXAMPLES

### Preparation of Materials

The following coating film materials were prepared.
Ultraviolet-curable resin coating material A (“TB3001” manufactured by ThreeBond Co., Ltd.)
Ultraviolet-curable resin coating material B (“TB3031” manufactured by ThreeBond Co., Ltd.)
Pigment (“Irgalite Orange D 2980” manufactured by BASF)

### Production of Sample Wire Protection Member

The pigment was added to each of the predetermined ultraviolet-curable resin coating materials to obtain compositions (mass %) as listed in Tables 1 to 3 below, and then were sufficiently mixed. Then, each of the pigment-containing ultraviolet-curable resin coating materials thus obtained was spray-coated onto the outer surface of a metal pipe (outer diameter: 20 mm) in the circumferential direction by using an air brush. Note that, the coated amount was appropriately adjusted such that the thicknesses of the coating films formed had values as listed in Tables 1 to 3 below. Then, each of the ultraviolet-curable resin coating materials that had been coated onto the metal pipe was irradiated with ultra-violet light of 3000 mJ/cm² that was generated by a metal halide lamp to cure the ultraviolet-curable resin coating material, thus forming a coating film. In this manner, the sample wire protection members were produced.

### Bonding Strength of Cured Product of Ultraviolet-Curable Resin Coating Material

The bonding strength of the cured products of each of the ultraviolet-curable resin coating materials was measured in accordance with the above-described measurement method.

### Elongation of Cured Product of Ultraviolet-Curable Resin Coating Material

The elongation of the cured product of each of the ultraviolet-curable resin coating materials was measured in accordance with the above-described measurement method.

### Heat Test

Each of the sample wire protection members was allowed to stand at a predetermined temperature for 120 hours, and the presence or absence of, and the degree of, cracking or detachment of the coating film were checked. At this time, the temperature was set to three levels, namely, 120° C., 150° C., and 180° C. Note that the present heat test simulated the temperature increase caused by the Joule heat generated as a result of a current passing through the wire that formed the wire harness inserted in the pipe harness. “A” indicates that no cracking or detachment was observed in the coating film. “B” indicates that cracking or detachment was observed in about 10% of the area of the coating film. “C” indicates that cracking or detachment was observed throughout the area of the coating film. Then, if the heat test results for the wire protection member were better than those for Samples 1C and 2C for comparison, it was determined that the cracking and the detachment of the coating caused by the film Joule heat could be inhibited.

The mixing ratio of the ultraviolet-curable resin coating material and the pigment, the measurement results of the bonding strength and the elongation, and the heat test results were collectively shown in Tables 1 to 3.

TABLE 1

| | Samples | | | | | | | | | |
|---|---|---|---|---|---|---|---|---|---|---|
| | 1 | 2 | 3 | 4 | 5 | 6 | 7 | 8 | 1C | 2C |
| Composition of ultraviolet- | | | | | | | | | | |
| curable resin coating material | | | | | | | | | | |
| (mass %) | | | | | | | | | | |
| Ultraviolet-curable resin | 99 | 98 | 97 | 96 | — | — | — | — | 95 | — |
| coating material A | | | | | | | | | | |
| Ultraviolet-curable resin | — | — | — | — | 99 | 98 | 97 | 96 | — | 95 |
| coating material B | | | | | | | | | | |
| Pigment | 1 | 2 | 3 | 4 | 1 | 2 | 3 | 4 | 5 | 5 |
| Thickness of coating film (μm) | 30 | 30 | 30 | 30 | 30 | 30 | 30 | 30 | 30 | 30 |
| Evaluation results | | | | | | | | | | |
| Bonding strength of cured | 3 | 1 | 0.5 | 0.3 | 5 | 3 | 2 | 1.5 | 0.2 | 1 |
| product (MPa) | | | | | | | | | | |
| Elongation of cured product | 150 | 100 | 50 | 20 | 5 | 5 | 2 | 1 | 5 | 0.5 |
| (%) | | | | | | | | | | |
| 120° C. heat test | A | A | A | A | A | A | A | A | A | A |
| 150° C. heat test | A | A | A | A | A | A | A | A | B | B |
| 180° C. heat test | A | A | A | B | A | A | A | B | C | C |

TABLE 2

| | Samples | | | | | | | | | |
|---|---|---|---|---|---|---|---|---|---|---|
| | 9 | 10 | 11 | 12 | 13 | 14 | 15 | 16 | 1C | 2C |
| Composition of ultraviolet- | | | | | | | | | | |
| curable resin coating material | | | | | | | | | | |
| (mass %) | | | | | | | | | | |
| Ultraviolet-curable resin | 99 | 98 | 97 | 96 | — | — | — | — | 95 | — |
| coating material A | | | | | | | | | | |
| Ultraviolet-curable resin | — | — | — | — | 99 | 98 | 97 | 96 | — | 95 |
| coating material B | | | | | | | | | | |
| Pigment | 1 | 2 | 3 | 4 | 1 | 2 | 3 | 4 | 5 | 5 |
| Thickness of coating film (μm) | 50 | 50 | 50 | 50 | 50 | 50 | 50 | 50 | 30 | 30 |
| Evaluation results | | | | | | | | | | |
| Bonding strength of cured | 3 | 1 | 0.5 | 0.3 | 5 | 3 | 2 | 1.5 | 0.2 | 1 |
| product (MPa) | | | | | | | | | | |
| Elongation of cured product | 150 | 100 | 50 | 20 | 5 | 5 | 2 | 1 | 5 | 0.5 |
| (%) | | | | | | | | | | |
| 120° C. heat test | A | A | A | A | A | A | A | A | A | A |
| 150° C. heat test | A | A | A | A | A | A | A | A | B | B |
| 180° C. heat test | A | A | A | B | A | A | A | B | C | C |

TABLE 3

| | Samples | | | | | | | | | |
|---|---|---|---|---|---|---|---|---|---|---|
| | 17 | 18 | 19 | 20 | 21 | 22 | 23 | 24 | 1C | 2C |
| Composition of ultraviolet- | | | | | | | | | | |
| curable resin coating material | | | | | | | | | | |
| (mass %) | | | | | | | | | | |
| Ultraviolet-curable resin | 99 | 98 | 97 | 96 | — | — | — | — | 95 | — |
| coating material A | | | | | | | | | | |
| Ultraviolet-curable resin | — | — | — | — | 99 | 98 | 97 | 96 | — | 95 |
| coating material B | | | | | | | | | | |
| Pigment | 1 | 2 | 3 | 4 | 1 | 2 | 3 | 4 | 5 | 5 |
| Thickness of coating film (μm) | 70 | 70 | 70 | 70 | 70 | 70 | 70 | 70 | 30 | 30 |
| Evaluation results | | | | | | | | | | |
| Bonding strength of cured | 3 | 1 | 0.5 | 0.3 | 5 | 3 | 2 | 1.5 | 0.2 | 1 |
| product (MPa) | | | | | | | | | | |
| Elongation of cured product | 150 | 100 | 50 | 20 | 5 | 5 | 2 | 1 | 5 | 0.5 |
| (%) | | | | | | | | | | |
| 120° C. heat test | A | A | A | A | A | A | A | A | A | A |
| 150° C. heat test | A | A | A | A | A | A | A | A | B | B |
| 180° C. heat test | A | A | A | B | A | A | A | B | C | C |

The tables demonstrate the following. For the wire protection member of Sample 1C, the bonding strength of the cured product of the ultraviolet-curable resin coating material was less than 0.3 MPa. Accordingly, detachment was observed in the coating film in the 150° C. heat test and the 180° C. heat test.

For the wire protection member of Sample 2C, the elongation of the cured product of the ultraviolet-curable resin coating material was less than 1%. Accordingly, cracking was observed in the coating film in 150° C. heat test and the 180° C. heat test.

On the other hand, the wire protection member of Samples 1 to 24 showed more favorable heat test results than the wire protection members of Samples 1C and 2C. These results confirmed that cracking and detachment of the coating film caused by Joule heat could be inhibited by setting the bonding strength and the elongation of the cured product of the ultraviolet-curable resin coating material forming the coating film in specific ranges even when the ultraviolet-curable resin coating material contained a pigment.

Although an embodiment of the present disclosure has been described in detail, the present disclosure is not limited to the above-described embodiment and working examples, and various modification can be made without departing from the gist of the present disclosure.

What is claimed is:

1. A wire protection member comprising:
a metal pipe in which a wire that forms a wire harness is to be inserted; and
a coating film that covers an outer surface of the metal pipe,
wherein the coating film is formed of a cured product of an ultraviolet-curable resin coating material, and
the cured product has a bonding strength of 0.3 MPa or more, and an elongation of 1% or more.

2. The wire protection member according to claim 1, wherein
the ultraviolet-curable resin coating material contains a pigment.

3. The wire protection member according to claim 2, wherein
a pigment content in the ultraviolet-curable resin coating material is 5 mass % or less.

4. The wire protection member according to claim 1, wherein
the coating film has a thickness of 30 μm or more and 100 μm or less.

5. The wire protection member according to claim 1, wherein
the ultraviolet-curable resin coating material contains at least one of a (meth)acrylate monomer and a (meth)acrylate oligomer.

6. A pipe harness comprising:
the wire protection member according to claim 1; and
the wire that forms the wire harness, the wire being inserted in the metal pipe of the wire protection member.
